(19) United States
(12) Patent Application Publication
(10) Pub. No.: US 2008/0266891 A1
(43) Pub. Date: Oct. 30, 2008

(54) Lamp for a Vehicle Headlight Featuring a Dimmed Function

(75) Inventors: Lukas Kupper, Aachen (DE); Hans-Alo Dohmen, Aidenhoven (DE); Kerstin Rosen, Bonn (DE); Colette Knight, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,763

(22) PCT Filed: Sep. 9, 2004
(86) PCT No.: PCT/IB2004/051720

§ 371 Date: Sep. 19, 2007

(51) Int. Cl. B60Q 1/00; H05B 37/02

(52) U.S. Cl. 362/538; 315/82

(57) ABSTRACT

The invention relates to a lamp for a vehicle headlamp with a low-beam function, which comprises an outer tube (3) and a light-emitting region (4) and which emits at least visible light of varying color from a number of regions of the outer tube (3), wherein at least a partial coating (2) is arranged on the outer tube (3) in such a way that, when implementing the low-beam function, the region of the traffic space which lies below the bright-dark cut-off (F) can be illuminated in defined regions with visible light of varying color.

The invention relates to a lamp for a vehicle headlamp with a low-beam function, which comprises an outer tube and a light-emitting region and which emits at least visible light of varying color from a number of regions of the outer tube.

Within the context of the invention, the term outer tube refers to the outermost tube in the case of lamps with a number of tubes and to the single tube in the case of lamps with just one tube.

Within the context of the invention, lamps are both incandescent lamps, in particular halogen lamps, and high intensity discharge lamps.

The light-emitting region is mainly the region of the incandescent coil in the case of incandescent lamps, and the region of the gas discharge in the case of high intensity discharge lamps.

Within the context of the invention, vehicle headlamps with a low-beam function are all headlamps which produce a bright-dark cut-off, such as for example pure low-beam headlamps, combined full-beam and low-beam headlamps, pure fog lamps, combined low-beam and fog lamps, and bending light headlamps.

Lamps which are used for this field of application are for example incandescent lamps, in particular halogen lamps, comprising one or two incandescent coils, or high intensity discharge lamps. With regard to their most important parameters, such lamps which are to be used for vehicle headlamps are subject to international standards, such as the SAE and ECE standards for example which specifically relate to the European and US markets. By way of example, the color properties to be observed in each case are precisely defined.

Headlamps with a low-beam function are usually equipped with lamps which emit visible light with a virtually identical color in all spatial directions, so that a traffic space which is illuminated homogeneously in terms of color is usually obtained.

The light color desired and/or required in each case can be achieved for example by means of conventional coatings which are applied in particular to the outer surface of the outer tube of the lamp in a known manner.

It is known that blue light is reflected better on obstacles in the traffic space, for example traffic signs, and thus can be perceived better or more quickly in particular by the driver of the vehicle which in this respect illuminates the traffic space, so that the traffic safety can thus usually be increased.

By contrast, yellow-colored light is less likely to dazzle the driver of the oncoming vehicle.

There is disclosed in WO 2004/053924 A2 a lamp for a vehicle headlamp with a low-beam function, which comprises an outer tube and a light-emitting region and which emits at least visible light of varying color from a number of regions of the outer tube, wherein at least a partial coating is arranged on the outer tube in such a way that, when implementing the low-beam function, at least the region of the traffic space which lies above the bright-dark cut-off can be at least partially illuminated with visible colored light which is scattered at the partial coating. At the same time, with this lamp, the region of the traffic space which lies below the bright-dark cut-off can be illuminated in defined regions with visible light of varying color. In respect of this partial coating, said document describes mainly absorption coatings since scattered light which is scattered at the partial coating should pass into the traffic space above the bright-dark cut-off. However, such scattered light is undesirable for certain applications.

The described solution relates in principle both to a high intensity discharge lamp and to an incandescent lamp. Particularly in respect of incandescent lamps, the color saturation of this solution does not in every case meet the requirements which are placed on increased traffic safety.

Obstacles or traffic signs, which in the case of traffic driving on the right are located at the right-hand edge of the road in the direction of travel of the vehicle, can be difficult for the driver of the vehicle to see, particularly in wet weather.

There is a need for lamps, in particular halogen lamps, which, when implementing the low-beam function, illuminate the traffic space below the bright-dark cut-off in a defined manner in a number of colors, and which above the bright-dark cut-off do not have any scattered light caused by a partial coating and produce a higher color difference in the headlamp bundle below the bright-dark cut-off. The color difference can be seen in the headlamp bundle if the color temperature of the filtered radiation differs from the color temperature of the unfiltered radiation by at least 200° K. and the width of the coated strip is preferably at least 1 mm.

It is an object of the invention to provide a lamp with such a coating and a lighting device comprising such a lamp, which can be efficiently manufactured in industrial mass production, has a perceivable higher color difference, and thus allows an increase in traffic safety when implementing the low-beam function.

The object of the invention is achieved by the features of claim 1.

It is essential to the invention that the partial coating is an interference coating which has a minimum width, and in the horizontal installed position of the lamp the vertical and horizontal extents of the light-emitting region are smaller than or equal to the vertical and horizontal extents of the partial coating, wherein the light-emitting region and this partial coating are arranged with respect to one another in such a way that the partial coating covers the light-emitting region based on a horizontal plane.

Interference coatings usually do not cause any scattered light. Moreover, they in principle make it possible, that is to say given an appropriate design of the coating, for one color to pass through the filter and for another color to be reflected. It is thus possible for different regions, in particular defined regions in the sense of desired regions, to be illuminated using just one partial coating. By means of just one partial interference coating, two precisely located regions in the traffic space can thus be illuminated with two different colors which are complementary to one another. This is not possible with one absorption coating; this would be possible with two absorption coatings but these two absorption coatings which differ in terms of their design would then each have to allow one color through. In technological terms, two different coatings are more complicated to apply than a single coating.

Moreover, it has been found that a defined dimensioning and position of the light-emitting region and of the partial coating are essential within the context of the invention. It has been found that, on a lamp, particularly a halogen lamp, a partial coating which runs along the tube axis generally does not produce a visible and particularly bright color effect which can be located in the traffic space.

Surprisingly, it has been found that not just the visibility but also the position of the colored light in the traffic space depends highly on the position of the partial coating on the lamp tube. A partial coating produces a visible color effect in the traffic space below the bright-dark cut-off only if said coating has a minimum width, that is to say the extent measured 90° to the longitudinal axis. It is moreover necessary that, in the horizontal installed position of the lamp, that is to say the longitudinal axis of the lamp is arranged virtually horizontally, the vertical and horizontal extents of the light-emitting region are smaller than or equal to the vertical and horizontal extents of the partial coating, based on a horizontal plane.

The color location of the radiation which passes through such a partial coating should lie at least 0.03 units above the color location of a comparable unfiltered radiation in the CIE color diagram.

A partial coating, which within the context of the invention does not cover the entire surface area of the lamp tube from which the emitted light emerges from the outer tube of the lamp when implementing the low-beam function, may be homogeneous or inhomogeneous in particular with regard to layer structure, thickness and composition, depending on the desired function of the coating or of the parts of the coating.

Such a coating may also consist of a number of different part-regions which are arranged in a defined manner on the lamp tube, in particular the outer tube, depending on their respective function.

In countries with traffic which drives on the right, such as Germany for example, the partial coating according to the invention is to be selected and arranged in such a way that, in the direction of travel of the vehicle, the right-hand side of the road and in particular the outer region thereof is illuminated with blue light and the left-hand side of the road is illuminated with yellow light.

The likelihood of dazzling oncoming traffic is reduced, wherein at the same time it is easier to see objects in the peripheral field of view on the right-hand side of the road. Given an appropriate modification of the invention, this can likewise be adapted to traffic which drive on the left.

Even in the case where the longitudinal axis of the light-emitting region is not located on the lamp axis, that is to say these are spaced apart from one another, the arrangement according to the invention can nevertheless be implemented, namely such that, in the horizontal installed position of the lamp, the vertical extent of the light-emitting region is in particular smaller than the vertical extent of the partial coating. The light-emitting region and this coating are arranged with respect to one another such that the partial coating covers the light-emitting region, based on an imaginary horizontal plane which runs through the longitudinal axis of the light-emitting region.

It is preferred that the interference coating lets through yellow light in particular and reflects blue light in particular. In this way, it is possible for the light intensity in the region of the right-hand edge of the road approx. 50 to 100 meters in front of the vehicle to be increased compared to a lamp without such an interference coating. Depending on the design of the respective interference coating, the reflected light additionally gives rise to a light-blue to blue-violet illumination of the traffic space and the light which is transmitted through the coating gives rise to a light-yellow to orange-yellow illumination.

With regard to the shape of the partial coating, it is preferred that this is shaped in a strip-like manner. This shape in particular allows simple production of this coating in technological terms.

In the horizontal installed position of the lamp, the vertical extent (minimum width) of the strip-like partial coating is preferably between 1 mm and 2.5 mm. The aforementioned value can be exceeded or undershot in particular depending on the corresponding vertical extent of the light-emitting region.

When implementing the low-beam function, the traffic space below the bright-dark cut-off can preferably be illuminated in such a way that yellow light dominates in a first region, blue light dominates in a second region and light which is not significantly affected by the partial coating dominates in a third region.

When implementing the low-beam function, the traffic space above the bright-dark cut-off can preferably be illuminated in such a way that white light dominates in this region.

The invention is moreover achieved by a lighting device which comprises at least one lamp as claimed in claims 1 to 8.

The invention will be further described with reference to examples of embodiments shown in the drawings to which, however, the invention is not restricted.

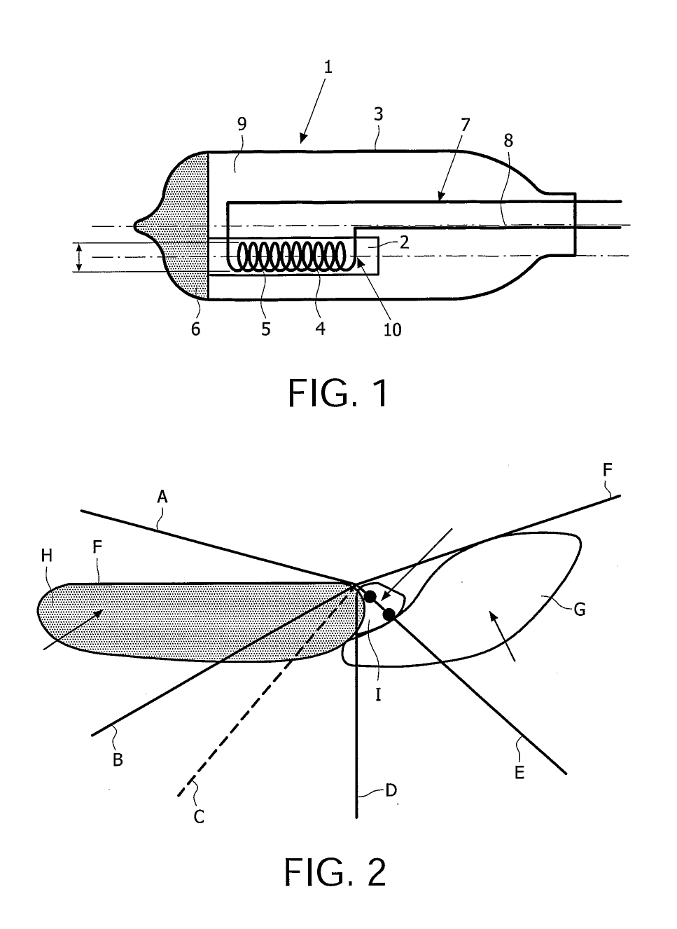

FIG. 1 shows a schematic side view of a halogen lamp for a reflection headlamp and

FIG. 2 shows a schematic diagram of a light distribution in the traffic space of a lamp as shown in FIG. 1.

FIG. 1 shows in a schematic side view one embodiment of a lamp 1 according to the invention, namely a halogen lamp, for a reflection headlamp, said lamp 1 being shown in a horizontal installed position. An incandescent coil 5 is arranged within the lamp tube, which in this case is also the outer tube 3 of the lamp 1, as the light source of the lamp 1. The incandescent coil 5, which is approx. 5 mm long and 1 mm wide, is connected to a return pole 7 and to a power supply 8 in a conventional manner.

The light-emitting region 4 is mainly delimited with regard to its outer contour by the region of the incandescent coil 5, in particular the outer regions thereof. The light-emitting region 4 can be described as more or less cylindrical, wherein its longitudinal axis runs parallel to the longitudinal axis 10 of the incandescent coil 5 and of the partial coating 2. The more or less cylindrical light-emitting region 4 has a diameter of approx. 1.2 mm and is approximately 5.2 mm long.

The outer tube 3 is connected in a gas-tight manner to a socket, which is not shown in FIG. 1. On the outer surface of the outer tube 3, at the end which points in the direction of the traffic space in the illustrated installed position, there is applied a protective screen 6 in the form of a partial, light-impermeable coating.

The partial coating 2 is arranged only on part of the outer surface of the outer tube 4.

The outer tube 4 moreover has a region 9 which does not bear any coating, so that mainly unfiltered light emerges from this region.

The partial coating 2 is an interference coating which comprises a number of layers.

The requirements in terms of heat-resistance of the partial coating 2 are determined in particular by the temperatures of 600 to 800° C. which often arise on the outer tube 3 of the lamp 1.

The partial coating 2, which is an interference coating, consists of at least two and at most nineteen layers and is applied by means of a sputtering method in a manner known per se, wherein the coated region is masked with a mechanical mask. In this method, silicone dioxide is used as a low-refractive material and titanium dioxide is used as a highly refractive material. The individual layers may in each case have a thickness of 20 to 120 nm, wherein the overall coating has a thickness of at least 50 nm and at most 1500 nm.

The width of this strip-like interference filter 2 is approx. 2 mm and its longitudinal extent is approx. 8 mm. This strip-like interference filter, having at least the width of the light-emitting region 4, is applied to the surface of the outer tube 4. The light-emitting region 4 and the partial coating 2 are thus arranged with respect to one another in such a way that the partial coating 2 covers the light-emitting region 4, based on an imaginary horizontal plane which is also the direction in which the observer looks towards the incandescent coil 5.

FIG. 2 schematically shows the light distribution of the lamp 1 according to the invention on a vertically arranged screen, e.g. 10 m in front of the vehicle, as shown in FIG. 1, when implementing the low-beam function. FIG. 2 contains the line A as the line on which the eyes of the driver of the oncoming vehicle move; B is the line of the left-hand edge of the road; C is the line of the center of the road; D is the line of the center of the right-hand lane; E is the line of the right-hand edge of the road; and F is the line of the bright-dark cut-off, G is the region of blue light which is delimited towards the top by the line F of the bright-dark cut-off, and H is the region of the yellow scattered light. Light which passes through the partial coating 2 is projected into the traffic space close to the bright-dark cut-off F. I shows the region which is illuminated by unfiltered light. The bright-dark cut-off F is the region in the traffic space which separates the traffic space illuminated by the headlamp from the traffic space which is not illuminated.

1. A lamp for a vehicle headlamp with a low-beam function, which comprises an outer tube (3) and a light-emitting region (4) and which emits at least visible light of varying color from a number of regions of the outer tube (3), wherein at least a partial coating (2) is arranged on the outer tube (3) in such a way that, when implementing the low-beam function, the region of the traffic space which lies below the bright-dark cut-off (F) can be illuminated in defined regions with visible light of varying color, characterized in that the partial coating (2) is an interference coating which has a minimum width, and in the horizontal installed position of the lamp (1) the vertical and horizontal extents of the light-emitting region (4) are smaller than or equal to the vertical and horizontal extents of the partial coating (2), wherein the light-emitting region (4) and this partial coating (2) are arranged with respect to one another in such a way that the partial coating (2) covers the light-emitting region (4) with respect to a horizontal plane.

2. A lamp as claimed in claim 1, characterized in that the light source of the lamp (1) is a halogen bulb.

3. A lamp as claimed in claim 1, characterized in that the interference coating lets through yellow light in particular and reflects blue light in particular.

4. A lamp as claimed in claim 1, characterized in that the longitudinal extent of the partial coating (2) is greater than the longitudinal extent of the light-emitting region (4).

5. A lamp as claimed in claim 1, characterized in that the partial coating (2) is shaped in a strip-like manner.

6. A lamp as claimed in claim 1, characterized in that, in the horizontal installed position of the lamp (1), the vertical extent of the strip-like partial coating (2) is between 1 mm and 3 mm.

7. A lamp as claimed in claim 1, characterized in that, when implementing the low-beam function, the traffic space below the bright-dark cut-off (F) can be illuminated in such a way that yellow light dominates in a first region (H), blue light dominates in a second region (G) and light which is not significantly affected by the partial coating (2) dominates in a third region (I).

8. A lamp as claimed in claim 1, characterized in that, when implementing the low-beam function, the traffic space above the bright-dark cut-off (F) can be illuminated in such a way that white light dominates in this region.

9. A lighting device, comprising at least a lamp (1) as claimed in claim 1.
